(19) United States
(12) Patent Application Publication
(10) Pub. No.: US 2023/0127025 A1
(43) Pub. Date: Apr. 27, 2023

(54) LOW-VISCOUS ISOCYANATE PREPOLYMERS BLOCKED WITH PHENOLS OBTAINABLE FROM CASHEW NUTSHELL OIL, METHOD FOR THE PRODUCTION THEREOF AND USE THEREOF

(71) Applicant: Covestro Deutschland AG, Leverkusen (DE)

(72) Inventors: Anna-Marie Zorn, Ettlingen (DE); Claudine Stoye, Köln (DE); Erkan Durgut, Bochum (DE); Karl H. Wuehrer, Köln (DE); Thomas Schucht, Kürten (DE)

(21) Appl. No.: 17/907,694

(22) PCT Filed: Apr. 6, 2021
(86) PCT No.: PCT/EP2021/058835

§ 371 Date: Sep. 29, 2022

(30) Foreign Application Priority Data
Apr. 8, 2020 (EP) 20168769.6

(51) Int. Cl. C08G 18/12; C08G 18/24; C08G 18/48; C08G 18/76; C08G 18/28; C09D 175/04

(52) U.S. Cl. CPC C08G 18/12; C08G 18/244; C08G 18/4825; C08G 18/7671; C08G 18/2825; C09D 175/04

(57) ABSTRACT

The present invention relates to novel solvent-free, blocked isocyanate prepolymers curing at room temperature, and to a method for the production thereof. Furthermore, the present invention relates to the use of said blocked isocyanate prepolymers for producing solvent-free reactive systems and to their use for producing adhesives, sealing compounds, casting compounds, molded parts or coatings, which are curing at room temperature.

The present invention relates to novel solvent-free blocked isocyanate prepolymers that cure at room temperature and to a process for the production thereof. The present invention also relates to the use of these blocked isocyanate prepolymers for the production of solvent-free reactive systems and to the use thereof in turn for the production of adhesives, sealing compounds, potting compounds, moldings or coatings that cure at room temperature.

A good and permanent elasticization of epoxy resins can be achieved by combining polyurethanes. In DE 23 38 256 A1, for example, high-molecular-weight, amine-terminated polyether urethane ureas were produced by reacting prepolymers containing free isocyanate groups with amines in highly dilute solutions and then curing with epoxy resins. However, the use of the solvents required for this is practically disadvantageous both from a technical and from a physiological standpoint. Conversely, the viscosity of the solvent-free reaction products that have been produced is too high for practical uses.

A process for producing elasticized moldings and textile fabrics is described in DE 24 18 041 A1. In this process, an epoxide is reacted with an amine compounds obtained by hydrolysis of ketimine or enamine prepolymers. With this process, it is possible to produce chemical-resistant thermosets having good adhesion and improved properties. The disadvantage of the process described is the high level of process complexity.

DE 21 52 606 A1 describes reactive systems based on alkylphenol-blocked polyisocyanates and polyamines, which can optionally also be cured in combination with epoxy resins. These reactive systems too have a number of use-related disadvantages, for example the reactive systems have relatively high viscosity and the blocking agent released has a comparatively low molecular weight, with the result that it migrates out of the coating over time and the adhesion of the coating to the substrate is no longer adequate.

In order to enable a selective reaction of polyisocyanate prepolymers with excess amounts of diamine, it has therefore often been proposed to use the polyisocyanates in blocked form, for example as described in DE 31 51 592 A1, EP 293 110 A2 or EP 082 983 A1. The blocking agents used with preference therein are phenols or substituted phenols. However, once the reaction with the polyamines has taken place, these substances, on account of their high boiling point, cannot be removed from the reaction mixture by distillation or can be removed only incompletely. The retention of the optionally substituted phenols in the mixture or in the plastic compound does however lead to the disadvantages already described.

EP 0 457 089 A2 on the other hand uses as blocking agents secondary amines having a preferably low boiling point. If these amines remain in the reaction mixture after deblocking, an odor nuisance can readily arise. After use in epoxy systems, the secondary amine can in principle be incorporated into the system, but this reaction proceeds relatively slowly, especially at low temperatures (for example room temperature), as a result of which some of the amines migrates out of the coating. In a particularly preferred application, the amine blocking agent is, after deblocking, removed from the reaction mixture by distillation. Although this procedure results in products having no odor nuisance, it is very laborious and therefore costly.

U.S. Pat. No. 6,060,574 A in addition discloses reactive compositions consisting of reversibly blocked organic polyisocyanates and at least one polyamine having at least two primary amino groups and optionally comprise in addition a compound containing oxirane groups. The blocking agents used for the organic polyisocyanates are hydrocarbon resins having phenolic OH groups. Blocked polyisocyanates of this kind are characterized by a significantly reduced reactivity toward polyamines by comparison with alkylphenol-blocked polyisocyanates. The organic polyisocyanates used may be prepolymers obtained by reacting polyhydroxy compounds with an excess of di- or polyisocyanates. The polyhydroxy compounds used may for example be polyether polyols obtainable by alkoxylation of suitable starter molecules (for example monomeric polyols).

WO 2006/037453 A2 describes a process for producing blocked polyisocyanates, wherein at least 50 mol % of the NCO groups had been blocked with a sterically hindered phenol. An analogous process is described in EP 1 650 243 A1.

EP 1 204 691 B1 describes solvent-free reactive systems based on blocked isocyanates and organic amines that cure at room temperature.

EP 1 578 836 B1 describes a process for producing polyurethane prepolymers having low viscosity for reactive systems that cure at room temperature.

WO 2015/153399 A1 describes a blocked prepolymer derived from natural oil, produced from an isocyanate-terminated prepolymer and a blocking agent derived from a natural oil such as cashew nut shell liquid having a content of 94% cardanol. In the processing of the blocked prepolymer, the high viscosity is a disadvantage. This is within a range from 50 000 Pas to 300 000 Pas. An analogous process is described in WO 2017/044402 A1.

All reversibly blocked isocyanate prepolymers described in the prior art that are produced by reacting an isocyanate prepolymer containing isocyanate groups with a blocking agent have thus far exhibited high viscosity due to intermolecular hydrogen bonding in the urethane group, which is a major disadvantage for the processing of corresponding reactive systems comprising polyamines and optionally epoxides. Spray application is usually not possible because of the high viscosity of such systems.

The object of the present invention was therefore to produce novel blocked isocyanate prepolymers that, because of their low viscosity, can be processed without problem into corresponding reactive systems comprising polyamines and optionally epoxides, and that are solvent-free and cure at room temperature.

The novel blocked isocyanate prepolymers should find use in the production of adhesives, sealing compounds, potting compounds, composites (fiber composite materials), moldings, and coatings. Possible fields of use are in particular anti-corrosion coatings in hydraulic steel engineering, shipbuilding (for example ballast tanks) and for pipelines and floor coatings.

The coatings produced from these reactive systems should have good adhesion, in particular wet adhesion, chemical resistance, impact resistance and shock resistance, while at the same time having flexibility and elasticity.

It has surprisingly been found that especially isocyanate prepolymers blocked with mixtures of phenolic blocking agents as described hereinbelow have significantly lower viscosity than isocyanate prepolymers blocked according to the prior art and can thus be processed particularly readily into reactive systems.

The present invention relates to blocking agents comprising or consisting of

cardanol and cardol in a weight ratio of 92:8 to 100:0

and at least one compound of general formula 1

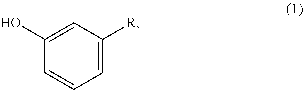

in which R is C₁₇H₃₃₋ₙ, where n=0, 2 or 4,
the compounds of formula 1 being present in a total amount of 0.1% to 3.0% by
weight based on the total weight of the blocking agent,

and

optionally at least one compound of general formula 2

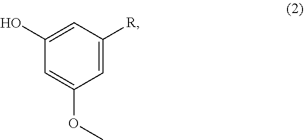

in which R is C₁₅H₃₁₋ₙ, where n=4 or 6,
the compounds of formula 2, if present, being present in a total amount of not more than 1.8% by weight based on the total weight of the blocking agent.

The sulfur content of the blocking agent is preferably less than 15 mg/kg, more preferably less than 12 mg/kg.

The present invention also provides a process for producing blocked isocyanate prepolymers, comprising or consisting of the reaction of

at least one prepolymer bearing isocyanate groups obtainable from the reaction of a composition comprising or consisting of
A. at least one aliphatic, cycloaliphatic, araliphatic and/or aromatic di- and/or polyisocyanate and
B. at least one polyhydroxy compound

with a blocking agent C according to the above description.

The present invention also provides blocked isocyanate prepolymers obtainable by the process described above.

Starting compounds A for the process according to the invention are any diisocyanates and/or polyisocyanates having aliphatically, cycloaliphatically, araliphatically and/or aromatically attached isocyanate groups.

Suitable diisocyanates A are any diisocyanates obtainable in various ways, for example by phosgenation in the liquid or gas phase or by a phosgene-free route, for example by thermal urethane cleavage. Preferred diisocyanates are those in the molecular weight range 140 to 400 having aliphatically, cycloaliphatically, araliphatically and/or aromatically attached isocyanate groups, for example 1,4-diisocyanatobutane, 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl isocyanatomethylcyclohexane (isophorone diisocyanate, IPDI), 4,4′-diisocyanatodicyclohexylmethane, 1-isocyanato-1-methyl-4(3)isocyanatomethylcyclohexane, bis(isocyanatomethyl)norbornane, 1,3- and 1,4-bis(2-isocyanatoprop-2-yl)benzene (TMXDI), 2,4- and 2,6-diisocyanatotoluene (TDI), 2,4′- and 4,4′-diisocyanatodiphenylmethane (MDI), 1,5-diisocyanatonaphthalene (NDI), norbornane diisocyanate (NBDI) or any desired mixtures of such diisocyanates. Particularly suitable are aromatic polyisocyanates such as naphthalene 1,5-diisocyanate (NDI), diisocyanatodiphenylmethane (MDI), poly(methylene phenyl isocyanate) (pMDI, polymeric MDI, crude MDI), diisocyanatomethylbenzene (tolylene 2,4- and 2,6-diisocyanate, TDI), in particular the 2,4- and 2,6-isomers, and technical mixtures of the two isomers. A particularly suitable aromatic diisocyanate is tolylene 2,4-diisocyanate and the technical mixture thereof consisting of 70 to 90% of tolylene 2,4-diisocyanate and 30 to 10% of tolylene 2,6-diisocyanate.

Suitable polyisocyanates A are any polyisocyanates having a uretdione, isocyanurate, allophanate, biuret, iminooxadiazinedione and/or oxadiazinetrione structure that are produced through modification of simple aliphatic, cycloaliphatic, araliphatic and/or aromatic diisocyanates, for example those of the type mentioned above, as described for example in J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053 and DE-A 3 928 503 or in EP-A 0 336 205, EP-A 0 339 396 and EP-A 0 798 299 or any desired mixtures of such polyisocyanates.

In the production of these polyisocyanates, the actual modification reaction is generally followed by a further process step for removing the unreacted excess monomeric diisocyanates. The monomers are removed by processes known per se, preferably by thin-film distillation under reduced pressure or by extraction with suitable solvents inert to isocyanate groups, for example aliphatic or cycloaliphatic hydrocarbons such as pentane, hexane, heptane, cyclopentane or cyclohexane.

In the process according to the invention, preference is given to using as starting component A polyisocyanates of the mentioned type that have a content of monomeric diisocyanates of less than 1% by weight, preferably less than 0.5% by weight, more preferably less than 0.3% by weight.

Particularly preferred polyisocyanates A for the process according to the invention are those of the mentioned type having exclusively aromatically attached isocyanate groups.

Very particularly preferred polyisocyanates A are those based on 2,4- and 2,6-diisocyanatotoluene (TDI) and the technical mixture thereof consisting of 70% to 90% of tolylene 2,4-diisocyanate and 30% to 10% of tolylene 2,6-diisocyanate.

The polyhydroxy compounds B used in the process according to the invention are any desired polyols, for example the polymeric polyether polyols, polyester polyols, polycarbonate polyols, polyurethane polyols and/or polyacrylate polyols known from polyurethane chemistry. Preference is given to using polyether polyols or mixtures of the mentioned polymeric polyols comprising at least one polyether polyol. Particular preference is given to using exclusively polyether polyols.

These generally have an average functionality of from 1.8 to 6.0, preferably from 1.8 to 4.0, more preferably from 1.9 to 2.2. The number-average molecular weight (determined to DIN 55672-1:2016-03) of these polyols is generally from 1000 to 10 000 g/mol, preferably from 1000 to 4000 g/mol, more preferably from 1000 to 2000 g/mol. It is also possible to use any desired mixtures of such polyols.

Suitable polyhydroxy compounds B for the process according to the invention are polyether polyols, for example those of the type mentioned in DE 26 22 951 B, column 6, line 65 to column 7, line 26, EP-A 0 978 523, page 4, line 45 to page 5, line 14, or WO 2011/069966, page 4, line 20 to page 5, line 23, provided they meet the above specifications regarding functionality and molecular weight. Polyether polyols that are particularly preferred as polyether polyols B are products of the addition of ethylene oxide and/or propylene oxide to propane-1,2-diol, propane-1,3-triol, glycerol, trimethylolpropane, ethylenediamine and/or pentaerythritol, or the polytetramethylene ether glycols in the abovementioned molecular weight range that are obtainable by polymerizing tetrahydrofuran, for example according to Angew. Chem. 72, 927 (1960). Very particular preference is given to products of the addition of ethylene oxide and/or propylene oxide to propane-1,2-diol (propylene glycol), wherein the polyether polyol contains 80% by weight of propylene glycol, more preferably 90% by weight of propylene glycol, most preferably 100% by weight of propylene glycol.

In component C, suitable blocking agents with phenolic compounds are used.

The blocking agent C used comprises cardanol having the general formula (3)

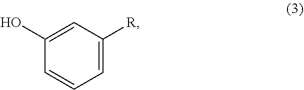

in which R is C₁₅H₃₁₋ₙ, where n=0, 2, 4 and 6,

and cardol having the general formula (4)

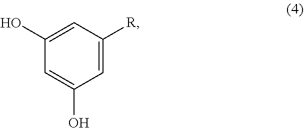

wherein R is C₁₅H₃₁₋ₙ, where n=0, 2, 4 and 6.

The phenolic blocking agent comprising cardanol and cardol can be obtained from cashew nut shell oil (CNSL), a waste product from the cultivation of cashew nuts.

The cardanol content in CNSL is at least 90% by weight based on the total weight, with the secondary components cardol, methylcardol and/or anacardic acid additionally present as secondary components. The CNSL is purified by thermal treatment, such as distillation. The general composition of the raw material for cashew nut shell oil is described in detail in WO 2017/207346.

Suitable are composition of cardanol and cardol in a weight ratio of 92:8 to 100:0, preferably 95:5 to 100:0, more preferably 97:3 to 100:0.

The blocking agent C additionally comprises at least one compound of general formula (1) in a total amount of 0.1% to 3.0% by weight, preferably 1.0% to 3.0% by weight, more preferably 1.2% to 2.8% by weight, in each case based on the total weight of the blocking agent.

The blocking agent C optionally comprises at least one compound of general formula (2) in a total amount of not more than 1.8% by weight, preferably not more than 1.5% by weight, particularly preferably not more than 0.5% by weight, very particularly preferably not more than 0.1% by weight, in each case based on the total weight of the blocking agent. Most preferably, the blocking agent is free of compounds of formula (2).

The blocking agent C preferably has an OH value of from 184 to 206, particularly preferably from 184 to 200, and very particularly preferably from 186 to 192.

The blocking reaction can be carried out with or without catalysts (D1) known per se from polyurethane chemistry, for example metalorganic compounds, such as tin(II) octoate, dibutyltin(II) diacetate, dibutyltin(II) laurate, 2,3-dimethyl-3,4,5,6-tetrahydropyrimidine or tertiary amines such as triethylamine or diazabicyclooctane or 1,8-diazabicyclo[5.4.0]undec-7-ene. The blocking reaction is preferably carried out using at least one of these catalysts.

The blocking reaction can be carried out using a suitable solvent that is inert toward the reactive groups of the starting components. Examples of suitable solvents are the customary paint solvents that are known per se, such as, for example ethyl acetate, butyl acetate, ethylene glycol monomethyl or monoethyl ether acetate, 1-methoxy-2-propyl acetate (MPA), 3-methoxy-n-butyl acetate, acetone, 2-butanone, 4-methyl-2-pentanone, cyclohexanone, toluene, xylene, chlorobenzene, white spirit, more highly substituted aromatics, of the kind sold for example under the names Solvent naphtha, Solvesso, Isopar, Nappar (ExxonMobil Chemical Central Europe, Cologne, Germany), and Shellsol (Shell Deutschland Oil GmbH, Hamburg, Germany), but also solvents such as propylene glycol diacetate, diethylene glycol dimethyl ether, dipropylene glycol dimethyl ether, diethylene glycol ethyl and butyl ether acetate, N-methylpyrrolidone and N-methylcaprolactam, or any desired mixtures of such solvents. The reaction is preferably carried out without solvent.

The content of free NCO groups in the blocked isocyanate prepolymers according to the invention is preferably <0.5% by weight, particularly preferably <0.2% by weight, very particularly preferably <0.1% by weight.

In the process according to the invention, component B is reacted with excess amounts of isocyanate component A, optionally in the presence of a catalyst D2. Any unreacted di- or polyisocyanate is then removed again by distillation, for example by thin-film distillation. The molar ratio of the OH groups in the polyether polyol component to the NCO groups in the di- or polyisocyanate is preferably between 1:1.5 and 1:20, more preferably between 1:1.8 and 1:5, and particularly preferably between 1:1.95 and 1:2.05.

The reaction of components B and A is generally carried out at a temperature of from 0 to 250° C., preferably from 20 to 140° C., and more preferably from 40 to 100° C., optionally using a catalyst component D2. Suitable catalysts for prepolymer formation (D2) are for example the catalysts already described above for component D1. When component A comprises aromatic diisocyanates or polyisocyanates having aromatically attached isocyanate groups, the prepolymerization reaction is preferably carried out without a catalyst.

When catalysts are used for the prepolymerization reaction and also for the blocking reaction, the same catalysts or catalyst mixtures are preferably used for both reactions.

The prepolymerization reaction can be carried out using a solvent. Suitable solvents are for example the solvents already described above for the blocking reaction. The reaction is preferably carried out without solvent.

For production of the products of the invention, the prepolymers containing isocyanate groups obtained from component A and component B, optionally using catalyst component D2, are in a further step reacted with blocking agent C at temperatures of from 40 to 100° C., preferably from 50 to 90° C. and more preferably from 60 to 80° C., optionally using a suitable catalyst component D1. The amount of component C used in the blocking reaction should correspond to at least 30 mol %, preferably 50 mol %, particularly preferably more than 95 mol %, of the amount of isocyanate groups to be blocked. A small excess of blocking agent may be advantageous in order to ensure complete reaction of all the isocyanate groups. The excess is generally not more than 20 mol %, preferably not more than 15 mol %, and more preferably not more than 10 mol %, based on the isocyanate groups to be blocked. The amount of component C used in the blocking reaction is therefore very particularly preferably 95 mol % to 110 mol % based on the amount of isocyanate groups in the isocyanate prepolymer that are to be blocked.

The components may be added in any desired order both during the production of the prepolymers containing isocyanate groups and during the blocking thereof.

However, preference is given to adding the polyisocyanate A to the initially charged polyether polyol B and lastly adding the blocking component C. This is done by initially charging a suitable reaction vessel with the polyether polyol B and heating this in the abovementioned temperature range (max. 250° C., preferably 20 to 140° C. and more preferably 40 to 100° C.) with optional stirring. On reaching the desired temperature, the di- or polyisocyanate A is then added with stirring. To speed up the reaction, a catalyst D2 may be added, which may be done at any point in time before, during or after the steps described above. The reaction mixture is then stirred until the theoretical NCO content of the isocyanate prepolymer to be expected according to the chosen stoichiometry, or a value slightly below this, has been reached. The isocyanate prepolymer thus obtained may be subjected to purification by distillation.

For the subsequent blocking reaction, the temperature of the reaction mixture is adjusted to a value between 40 and 100° C. On reaching the desired temperature, the blocking agent C is added. To speed up the blocking reaction, a suitable catalyst D1, such as dibutyltin (II) dilaurate, may be added. This can be done before or after adjusting the temperature and before or after adding the blocking agent. The reaction mixture is then stirred until the content of free isocyanate groups is less than 0.5% by weight, preferably less than 0.2% by weight, more preferably less than 0.1% by weight. The reaction mixture is then cooled and a reaction quencher such as benzoyl chloride optionally also added.

In a further embodiment of the process according to the invention, a suitable reaction vessel is charged with the di- or polyisocyanate A and this is heated to 40 to 100° C. with optional stirring. On reaching the desired temperature, the polyether polyol B is then added while stirring. To speed up the reaction, a catalyst D2 may be added, which may be done at any point in time before, during or after the steps described above. The reaction mixture is stirred until the theoretical NCO content of the isocyanate prepolymer to be expected according to the chosen stoichiometry, or a value slightly below this, has been reached. The further course of the reaction then takes place as already described.

The present invention further provides the above-described blocked isocyanate prepolymers having a viscosity, measured to DIN EN ISO 3219:1994-10 at 23° C., of less than 40 000 mPas, preferably less than 35 000 mPas, more preferably less than 30 000 mPas.

The invention in addition provides reactive systems comprising or consisting of
a) at least one blocked isocyanate prepolymer according to the invention,
b) at least one organic compound having at least 2 primary amino groups,
c) optionally a compound having at least one oxirane group and an average oxirane functionality of >1, and
d) optionally products from reactions of components a to c with one another,
e) optionally catalysts and/or auxiliaries and/or additives.

The amines in component b are polyamines having at least two primary amino groups per molecule and optionally also secondary amino groups and preferably having an average molecular weight of 60 to 500. Suitable examples are ethylenediamine, 1,2- and 1,3-diaminopropane, 1,4-diaminobutane, 2,2,4- and/or 2,4,4-trimethylhexamethylenediamine, the isomeric xylenediamines, 1,4-diaminocyclohexane, 4,4′-diaminodicyclohexylmethane, 1,3-diaminocyclopentane, 4,4′-diaminodicyclohexyl sulfone, 4,4′-diaminodicyclohexylpropane-1,3, 4,4′-diaminodicyclohexylpropane-2,2, 3,3′-dimethyl-4,4′-diaminodicyclohexylmethane, 3-aminomethyl-3,3,5-trimethylcyclohexylamine (isophoronediamine), 3(4)-aminomethyl-1-methylcycloliexylamine, technical grade bisaminomethyltricyclodecane, octahydro-4.7-methanoindene-1.5-dimethanamine, or also polyamines that, in addition to at least two primary amino groups, also have secondary amino groups, for example diethylenetriamine or triethylenetetramine

Particular preference is given to polyamines, especially diamines in the above molecular weight range that contain one or more cycloaliphatic rings. These include for example 1,4-diaminocyclohexane, 4,4′-diaminodicyclohexylmethane, 1,3-diaminocyclopentane, 4,4′-diaminodicyclohexyl sulfone, 4,4′-diaminodicyclohexylpropane-1,3, 4,4′-diaminodicyclohexylpropane-2,2, 3,3′-dimethyl-4,4′-diaminodicyclohexylmethane, 3-aminomethyl-3,3,5-trimethylcyclohexylamine (isophoronediamine), 3- and 4-aminomethyl-1-methylcyclohexylamine or technical grade bisaminomethyltricyclodecane.

It is also possible to use as a constituent of the amine component adducts produced by reacting an excess of the mentioned polyamines with epoxy resins of the type mentioned below.

Also employable in component b are polyetheramines produced by reacting polyether polyols with ammonia and sold for example by Huntsman under the Jeffamine® trade name.

Polyamide resins are also in addition suitable as a constituent of component b. Polyamide resins of this kind, which include polyaminoamides and polyaminoimidazolines, are sold inter alia by Henkel KGaA under the “Versamid®” trade name.

It is of course also possible to use mixtures of the mentioned polyamines as amine component b.

Compounds of component c are compounds having oxirane groups. Suitable compounds having oxirane groups are epoxy resins that contain on average more than one epoxy group per molecule. Examples of suitable epoxy resins are glycidyl ethers of polyhydric alcohols such as butanediol, hexanediol, glycerol, hydrogenated diphenylolpropane or polyhydric phenols such as resorcinol, diphenylolpropane-2,2 (bisphenol A), diphenylolmethane (bisphenol F) or phenol-aldehyde condensates. Glycidyl esters of polybasic carboxylic acids, such as hexahydrophthalic acid or dimerized fatty acid, may be used.

Particular preference is given to using liquid epoxy resins based on epichlorohydrin and diphenylolpropane-2,2 (bisphenol A) or diphenylolmethane (bisphenol F) or mixtures thereof. If desired, the viscosity of the mixtures can be lowered with monofunctional epoxy compounds, thereby improving processing. Examples of these are aliphatic and aromatic glycidyl ethers such as butyl glycidyl ether, phenyl glycidyl ether or glycidyl esters such as Versatic acid glycidyl ester or epoxides such as styrene oxide or 1,2-epoxydecane.

In the preferably solvent-free, room-temperature-curing reactive systems of the invention, there are generally, per epoxy group of component c, 0.4 to 0.9, preferably 0.5 to 0.8, primary amino groups of component b and 0.02 to 0.6, preferably 0.03 to 0.5, blocked isocyanate groups of component a.

To produce ready-to-use mixtures, it is possible to incorporate into the reactive systems of the invention the customary catalysts, auxiliaries and additives, for example fillers, solvents, leveling aids, pigments, reaction accelerators or viscosity regulators. Examples include reaction accelerators such as salicylic acid, bis(dimethylaminomethyl)phenol or tris(dimethylaminomethyl)phenol, fillers such as sands, rock flour, silica, asbestos flour, kaolin, talc, metal powders, tar, pitch, asphalt, cork scraps, polyamides, plasticizers such as phthalic esters, or other viscosity regulators such as benzyl alcohol.

It is of course possible, for use-related purposes, to optionally add to the ready-to-use mixture up to 20% by weight, preferably up to 10% by weight, more preferably up to 5% by weight, of a solvent or paint solvent of the type already described above. If solvents are to be used at this point, it is also possible to dispense with the removal of solvent if solvents had been used during the synthesis of the polyurethane prepolymers of the invention.

However, very particular preference is for the purposes of the present invention given to solvent-free, ready-to-use reactive systems.

In the process of the invention for producing the reactive systems, component a is mixed with component b in either order, preferably with stirring. Components c and d can then be additionally added, likewise in either order and again optionally with stirring.

The production of the reactive systems of the invention from a and b and optionally c and/or d preferably takes place at temperatures of from −20° C. to 50° C., more preferably from 0° C. to 40° C.

The polyisocyanates according to the invention and the reactive systems are both suitable for the production of coatings, adhesives, sealing compounds, potting compounds or moldings in all fields of use where good adhesion, chemical resistance, and also high impact and shock resistance allied with good flexibility and elasticity are required. The systems according to the invention are particularly suitable as anti-corrosion coatings. Particularly when exposed to aggressive media, for example in the case of ballast tank coatings, the systems are characterized by good wet adhesion and good adhesion under cathodic protection conditions.

The present invention further provides for the use of the blocked isocyanate prepolymers in the production of polyurethane plastics.

In addition, the present invention further provides for the use of the reactive systems of the invention for the production of coatings, in particular anti-corrosion coatings, adhesives, sealing compounds, potting compounds, primers or moldings.

The present invention likewise provides coatings, in particular anti-corrosion coatings, adhesives, sealing compounds, potting compounds, primers and moldings comprising the blocked isocyanate prepolymers according to the above description, and also substrates coated with these coatings, especially with an anti-corrosion coating of this kind.

The reactive systems of the invention can be used on a very wide variety of substrates. Examples include mineral substrates, for example ones made of concrete and/or stone, metallic substrates, for example ones made of iron, steel, copper, brass, bronze, aluminum or titanium, and alloys of the mentioned metals, and plastics, for example in the form of existing coatings on for example the mentioned metallic or mineral substrates.

In addition, the blocked isocyanate prepolymers of the invention show excellent compatibility with components b and c, since the reaction of epoxy resin/amine and blocked isocyanate/amine can be adjusted such that the reactive systems result in a compatible blend at room temperature.

The reactive systems of the invention can be applied to the surface to be coated for example by pouring, painting, dipping, spraying, flow-coating, knifecoating or rolling. Depending on the field of use, layer thicknesses of 10 Pm (e.g. for thin anti-corrosion coatings) up to several centimeters (e.g. for crack-bridging potting compounds) can thus be achieved.

Depending on the chosen composition of the reactive systems of the invention, they cure at ambient conditions, i.e. at temperatures of preferably −30° C. to 50° C. and a relative humidity of preferably 10% to 90%, within a few minutes up to a few days. Curing can also be accelerated by increasing the temperature, i.e. to above the mentioned 50° C., which can also be desirable in practice.

The present invention is more particularly elucidated hereinafter with reference to examples and comparative examples, but without restricting it thereto.

### EXAMPLES

All percentages are based on weight unless otherwise noted.

The composition of the phenolic blocking agent was determined by gas chromatography. The measurement was carried out on an Agilent 6890 GC using an Optima 1 MS Accent column (30 m×0.25 mm×0.5 μm) and an MSD 5973 mass spectrometer detector. The carrier gas used was helium at a flow rate of 3 mL/min. The column temperature was 80° C. and was then increased at 6° C./min to 320° C. and held for 20 min on reaching the target temperature. The ionization energy for the GC/MS detection was 70 eV. Injection temperature was 270° C. with a split ratio of 20:1.

The sulfur content of the phenolic blocking agent was determined by inductively coupled plasma optical emission spectrometry (ICP-OES). For this, the sample was first solubilized by microwave digestion. The optical spectroscopy was carried out using an ICP-OES instrument from Spectro (Arcos II) against certified standards. The principal detection line used for sulfur was the 180.731 nm line. To rule out possible interference, a second line (182.034 nm) was observed in parallel.

All viscosity measurements were recorded using a Physica MCR 51 rheometer from Anton Paar Germany GmbH (Germany) to DIN EN ISO 3219:1994-10 at a shear rate of 250 s⁻¹.

NCO contents were determined titrimetrically to DIN EN ISO 11909:2007-05.

OH values were determined titrimetrically based on DIN 53240 part 2.

The tensile stress at break and elongation at break were determined based on DIN EN ISO 527-2:2012-06.

The further tear strength was determined to ISO 34-1:2016-06.

The Shore A and Shore D hardness tests were carried out to DIN 53505:2000-08.

Epilox T19-34/700 is a liquid epoxy resin based on bisphenol A and bisphenol F having an epoxy equivalent of 165-180 and a corresponding epoxy content of 23.9-26.1% (both values to DIN 16945:1989-03), obtainable from Overlack GmbH, Germany. Efka® SI 2008 is an additive for deaeration and defoaming, obtainable from BASF AG, Ludwigshafen, Germany, and TCD Diamine is octahydro-4,7-methano-1H-indenedimethylamine, Oxea, Marl, Germany

### Example 1

a) 908.0 g of a polyether polyol having a functionality of 2 and an OH value of 56, produced by propoxylation of propylene glycol, was prepolymerized with 158.0 g of 2,4-diisocyanatotoluene/2,6-diisocyanatotoluene (ratio=80/20) for 3 hours at 90° C. until the theoretical NCO content of 3.6% was reached. To this was then added 324.0 g of phenolic blocking agent 1 (NX 2026, commercial product from Cardolite Specialty Chemicals Europe NV) having an OH value of 191 and containing cardanol and cardol in a weight ratio of 100:0, 1.7% of the compound of general formula (I), 0% of the compound of general formula (II) and a sulfur content of less than 10 ppm, catalyzed with 1.6 g of tin(II) octoate, and the mixture was stirred at 65° C. until the NCO content was below 0.4%.

2.1 g of benzoyl chloride was then added and the mixture was stirred for a further 30 minutes.

The blocked isocyanate prepolymer thus obtained is characterized by the following characteristics:

| Viscosity (23° C.) | 27 500 mPas |
|---|---|
| Content of free NCO | 0.22% |

b) 40 g of the blocked isocyanate prepolymer from a) was added with 40 g of Epilox T19-34/700, 0.8 g of oleic acid, 0.4 g of Efka® SI 2008, and 0.4 g of benzyl alcohol and stirred until a homogeneous mixture had formed. The TCD Diamine curing agent was then added and the mixture mixed again until homogeneous. The mixture was poured out in a layer approx. 1.5 mm thick. After a few hours a transparent,

highly elastic plastic material having the following mechanical characteristics was obtained:
Tensile stress at break: 15.5 N/mm²
Elongation at break: 40.0%
Further tear strength: 51.9 N/mm
Shore A: 95
Shore D: 63

### Examples 2 to 9

Further blocked isocyanate prepolymers were produced according to the process described in example 1 using various phenolic blocking agents. The resulting characteristics of the blocked isocyanate prepolymers and the mechanical characteristics resulting from the corresponding reactive systems are summarized in the table below.

TABLE 1
Overview of the examples 1 to 9 carried out:

| | Example | | | | | | | | |
|---|---|---|---|---|---|---|---|---|---|
| | According to the invention | | | | | | | Comparative | |
| | 1 | 2 | 3 | 4 | 5 | 6 | 7 | 8 | 9 |
| Blocking agent: | | | | | | | | | |
| NX-2026 (Cardolite Specialty | x | x | x | x | | | | | |
| Chemicals Europe N.V.) | | | | | | | | | |
| NX-2025 (Cardolite Specialty | | | | | x | x | | | |
| Chemicals Europe N.V.) | | | | | | | | | |
| GP-502 (Golden Cashew Products | | | | | | | x | | |
| Pvt. Ltd) | | | | | | | | | |
| Cardanol (Klaus F. Meyer GmbH) | | | | | | | | x | x |
| Cardanol:cardol | 100:0 | 100:0 | 100:0 | 100:0 | 97:3 | 98:2 | 95:5 | 90:10 | 89:11 |
| Compound 1 [%] | 1.7 | 1.1 | 1.2 | 1.2 | 2.8 | 2.6 | 2.1 | 2.8 | 2.8 |
| Compound 2 [%] | 0.0 | 0.0 | 0.1 | 0.0 | 1.8 | 1.5 | 0.8 | 1.9 | 2.1 |
| OH value | 191 | 191 | 189 | 189 | 200 | 194 | 198 | 209 | 215 |
| Sulfur [mg/kg] | <12 | <12 | <12 | <12 | <12 | <12 | <12 | 18 | 31 |
| Blocked isocyanate prepolymer: | | | | | | | | | |
| Viscosity [mPas] | 27500 | 30300 | 26000 | 24100 | 25800 | 27300 | 33500 | 43000 | 52700 |
| Content of free NCO [%] | 0.22 | 0.29 | 0.27 | 0.25 | 0.27 | 0.35 | 0.24 | 0.33 | 0.27 |
| Reactive system: | | | | | | | | | |
| Tensile stress at break [N/mm²] | 15.5 | 20.2 | 20.7 | 18.3 | 16.8 | 19.7 | 19.7 | 20.6 | 21.9 |
| Elongation at break [%] | 40 | 23.2 | 33.5 | 26.8 | 19.4 | 29.5 | 22.8 | 25.1 | 29.6 |
| Further tear strength [N/mm] | 51.9 | 69.0 | 66.0 | 64.7 | 63.9 | 53.2 | 68.9 | 70.5 | 64.3 |
| Shore A | 95 | 93 | 93 | 98 | 97 | 95 | 92 | 94 | 89 |
| Shore D | 63 | 65 | 57 | 58 | 57 | 58 | 52 | 56 | 57 |

1. A blocking agent comprising cardanol and cardol in a weight ratio of 92:8 to 100:0 and at least one compound of general formula 1 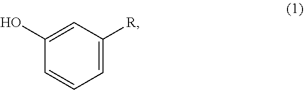
in which R is C₁₇H₃₃₋ₙ, where n=0, 2 or 4,
the compounds of formula 1 being present in a total amount of 0.1% to 3.0% by weight, based on the total weight of the blocking agent,
and
optionally at least one compound of general formula 2 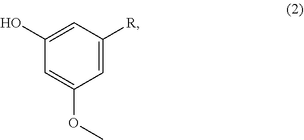
in which R is C₁₅H₃₁₋ₙ, where n=4 or 6,
the compounds of formula 2, if present, being present in a total amount of not more than 1.8% by weight, based on the total weight of the blocking agent.

2. The blocking agent as claimed in claim 1, wherein the blocking agent has an OH value of from 184 to 206.

3. The blocking agent as claimed in claim 1 having a sulfur content of less than 15 mg/kg.

4. A process for producing blocked isocyanate prepolymers, comprising reacting
at least one prepolymer bearing isocyanate groups obtained from the reaction of a composition comprising
A. at least one aliphatic, cycloaliphatic, araliphatic and/or aromatic di- and/or polyisocyanate and
B. at least one polyhydroxy compound
with
a blocking agent C as claimed in claim 1.

5. The process as claimed in claim 4, wherein component A comprises at least one di- and/or polyisocyanate based on naphthalene 1,5-diisocyanate, diisocyanatodiphenylmethane, poly(methylene phenyl isocyanate), diisocyanatomethylbenzene.

6. The process as claimed in claim 4, wherein component B comprises at least one polyhydroxy compound, having an OH functionality of 1.8 to 6.0 and a number-average molecular weight of from 1000 g/mol to 10 000 g/mol.

7. The process as claimed in claim 4, wherein component B comprises at least one polyether polyol that is a product of the addition of ethylene oxide and/or propylene oxide to propane-1,2-diol, propane-1,3-diol, glycerol, trimethylolpropane, ethylenediamine and/or pentaerythritol, or that is a polytetramethylene ether glycol obtained by polymerizing tetrahydrofuran.

8. The process as claimed in claim 1, wherein the at least one prepolymer bearing isocyanate groups obtained from the reaction of the composition comprising components A and B is, before reaction with component C, at least partially freed, by distillation, of unreacted di- and/or polyisocyanate of component A.

9. The process as claimed in claim 4, wherein the reaction of the composition comprising components A and B with component C takes place in the presence of a catalyst D1.

10. A blocked isocyanate prepolymer obtained by a process as claimed in claim 4.

11. The blocked isocyanate prepolymer as claimed in claim 10 having a viscosity, measured to DIN EN ISO 3219:1994-10 at 23° C., of less than 40 000 mPas.

12. A reactive system comprising
a) at least one blocked isocyanate prepolymer as claimed in claim 10,
b) at least one organic compound having at least 2 primary amino groups,
c) optionally a compound having at least one oxirane group and an average oxirane functionality of >1, and
d) optionally products from reactions of components a to c with one another,
e) optionally catalysts, auxiliaries, and additives.

13. A method of producing a polyurethane plastic, comprising using the blocked isocyanate prepolymer as claimed in claim 10 to produce the polyurethane plastic.

14. A method of producing a coatings, in particular anti-corrosion coatings, adhesives, sealing compounds, potting compounds, primers or moldings, comprising using the reactive system of claim 12 to produce the coating.

15. A coating, in particular anti-corrosion coatings, adhesives, sealing compounds, potting compounds, primers and moldings comprising the blocked isocyanate prepolymer as claimed in claim 10.

16. A coated substrate, comprising a coating as claimed in claim 15 applied to a substrate.
